(19) United States
(12) Patent Application Publication
(10) Pub. No.: US 2019/0179970 A1
(43) Pub. Date: Jun. 13, 2019

(54) COGNITIVE HUMAN INTERACTION AND BEHAVIOR ADVISOR

(71) Applicant: International Business Machines Corporation, Armonk, NY (US)

(72) Inventors: Brian E. Bissell, Fairfield, CT (US); Kristi A. Farinelli, Philadelphia, PA (US); Rahul P. Akolkar, Lexington, KY (US); MANALI JAIRAM CHANCHLANI, Jersey City, NJ (US)

(21) Appl. No.: 15/834,139

(22) Filed: Dec. 7, 2017

(51) Int. Cl. G06F 17/30; G06N 5/04

(52) U.S. Cl. CPC G06F 17/30976; G06N 5/04; G06F 17/30525

(57) ABSTRACT

In an approach for providing a recommendation for human interaction in an environment, a processor receives information from one or more devices in an area. A processor analyzes the information to identify at least two people and a context of an interaction, wherein a first person has the interaction with a second person. A processor applies a behavioral model to the context and the interaction to identify a recommendation, wherein the behavioral model is a model of a plurality of previous interactions in a plurality of areas, a plurality of contexts associated to the plurality of previous interactions, and a plurality of recommendations associated to the plurality of previous interactions. A processor provides the recommendation to the first person.

### BACKGROUND

The present invention relates generally to the field of social interaction, and more particularly to providing a recommendation for human interaction in an environment.

Social interaction is any relationship between two or more individuals. Social interaction derived from individual agency forms the basis of social structure and the basic object for analysis by social scientists. Categorizing social interactions enables observational and other social research, collective consciousness, etc. Forms of relation and interaction may be defined as follows: first and most basic are animal-like behaviors (i.e., various physical movements of the body); then, there are actions (i.e., movements with a meaning and purpose); then, there are social behaviors, or social actions, which address, directly or indirectly, other people and solicit a response; next, there are social contacts that are a pair of social actions that form the beginning of social interactions.

### SUMMARY

Aspects of an embodiment of the present invention disclose a method, computer program product, and computing system for providing a recommendation for human interaction in an environment. A processor receives information from one or more devices in an area. A processor analyzes the information to identify at least two people and a context of an interaction, wherein a first person has the interaction with a second person. A processor applies a behavioral model to the context and the interaction to identify a recommendation, wherein the behavioral model is a model of a plurality of previous interactions in a plurality of areas, a plurality of contexts associated to the plurality of previous interactions, and a plurality of recommendations associated to the plurality of previous interactions. A processor provides the recommendation to the first person.

### BRIEF DESCRIPTION OF THE DRAWINGS

FIG. 1 depicts a block diagram of a computing system, in accordance with an embodiment of the present invention.

FIG. 2 depicts a flowchart of the steps of a recommendation program, executing within the computing system of FIG. 1, for providing a recommendation for human interaction in an environment.

FIG. 3 depicts a block diagram of components of the server and/or the computing devices of FIG. 1, in accordance with an embodiment of the present invention.

### DETAILED DESCRIPTION

Embodiments of the present invention recognize that difficult social interactions arise between partners/spouses, children and parents, teachers and students, the public, and even individuals working alone. Embodiments of the present invention recognize that using merely expert advice, formal education and training, or reminders/timers often are forgotten in a new or stressful situation.

Embodiments of the present invention propose a solution that continuously monitors an environment (e.g., a room); uses classification to identify what activity and interaction is likely currently taking place (e.g., classifying the interaction as a collaboration, conflict, or otherwise); if needed, maps the context and recognized interaction to beneficial alternatives, based upon advice from experts; when appropriate, provides the next best positive action the users can take, and at the same time, logs the situation and recommended action; and, if the situation persists, provides the next best possible guidance. Embodiments of the present invention disclose an approach to provide a recommendation for human interaction in an environment.

Embodiments of the present invention will now be described in detail with reference to the Figures.

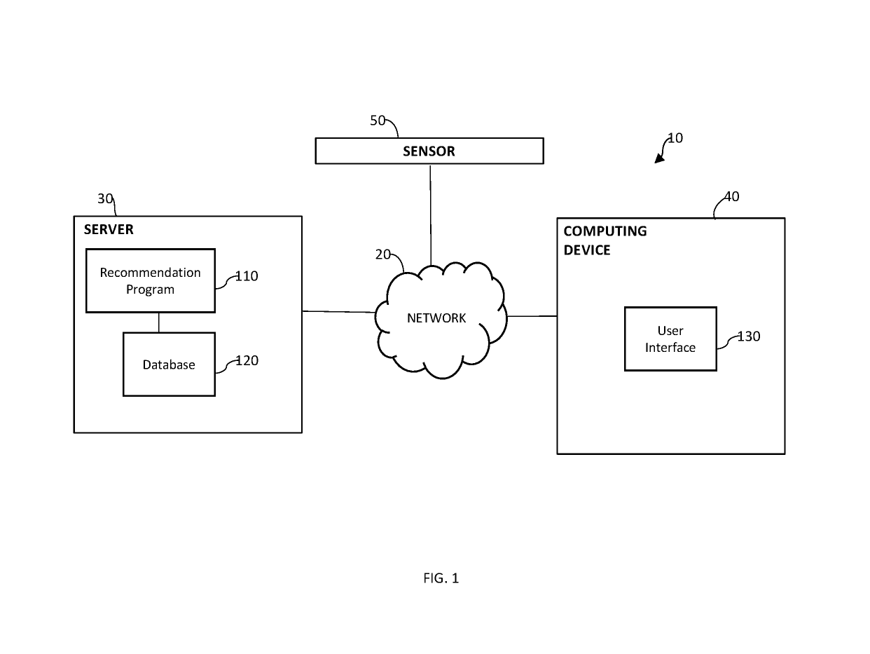

FIG. 1 depicts a block diagram of computing system 10, in accordance with one embodiment of the present invention. FIG. 1 provides an illustration of one embodiment and does not imply any limitations with regard to the environments in which different embodiments may be implemented.

In the depicted embodiment, computing system 10 includes server 30, computing device 40, and sensor 50 interconnected over network 20. Network 20 may be a local area network (LAN), a wide area network (WAN) such as the Internet, a cellular data network, any combination thereof, or any combination of connections and protocols that will support communications between server 30, computing device 40, and sensor 50, in accordance with embodiments of the invention. Network 20 may include wired, wireless, or fiber optic connections. Computing system 10 may include additional computing devices, servers, or other devices not shown.

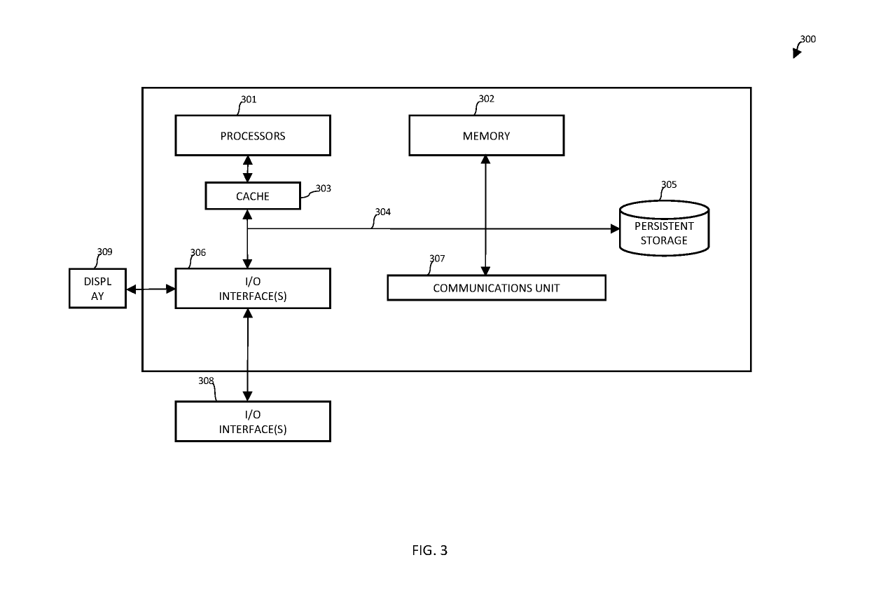

Server 30 may be a management server, a web server, or any other electronic device or computing system capable of processing program instructions and receiving and sending data. In some embodiments, server 30 may be a laptop computer, tablet computer, netbook computer, personal computer (PC), a desktop computer, or any programmable electronic device capable of communicating with computing device 40 and sensor 50 via network 20. In other embodiments, server 30 may represent a server computing system utilizing multiple computers as a server system, such as in a cloud computing environment. In another embodiment, server 30 represents a computing system utilizing clustered computers and components to act as a single pool of seamless resources. In the depicted embodiment, server 30 contains recommendation program 110 and database 120. In other embodiments, server 30 may include recommendation program 110, database 120, and/or other components, as depicted and described in further detail with respect to FIG. 3.

Computing device 40 may be a personal device, virtual assistant device, desktop computer, laptop computer, netbook computer, tablet computer, management server, web server, or application server. In general, computing device 40 may be any electronic device or computing system capable of processing program instructions, sending and receiving data, and communicating with other devices over a network. In the depicted embodiment, computing device 40 contains user interface 130. In other embodiments, computing device 40 may include user interface 130 and/or other components, as depicted and described in further detail with respect to FIG. 3.

Sensor 50 may be any device capable of detecting events or changes in an environment and providing a corresponding output. There may be one or more sensors 50. In one embodiment, sensor 50 may provide a corresponding output of a change in human interaction within an environment to recommendation program 110. In other embodiments, sensor 50 may provide a corresponding output of a change in the number of people within an environment. Examples of sensor 50 may be, but are not limited to: weight scales, cameras, audio receivers, video receivers, GPS, and/or facial recognition devices. In some embodiments, sensors, such as sensor 50 may be operably affixed to a wall, floor, computing device, or anything else within an environment being monitored. In other embodiments, sensor 50 may include multiple components, as depicted and described in further detail with respect to FIG. 3.

Recommendation program 110 provides a recommendation for human interaction in an environment. In doing so, recommendation program 110 receives information. Recommendation program 110 analyzes the information. Recommendation program 110 identifies a recommendation. Recommendation program 110 provides the recommendation to a person. In the depicted embodiment, recommendation program 110 resides on server 30. In other embodiments, recommendation program 110 may reside on another server, computing device 40, or another computing device, provided that recommendation program 110 can access database 120 and user interface 130.

Database 120 may be a repository that may be written to and/or read by recommendation program 110. In some embodiments, recommendation program 110 may retrieve information from multiple devices and store the information to database 120. In other embodiments, database 120 may store recommendations. In the depicted embodiment, database 120 resides on server 30. In other embodiments, database 120 may reside on another server, computing device 40, or another computing device, provided that database 120 is accessible to recommendation program 110.

User interface 130 may be any user interface used to access information from server 30, such as information gathered or produced by recommendation program 110. In some embodiments, user interface 130 may be a generic web browser used to retrieve, present, and negotiate information resources from the Internet. In other embodiments, user interface 130 may be a software program or application that enables a user at computing device 40 to access server 30 over network 20. In the depicted embodiment, user interface 130 resides on computing device 40. In other embodiments, user interface 130 may reside on another computing device or another server, provided that user interface 130 is accessible to recommendation program 110.

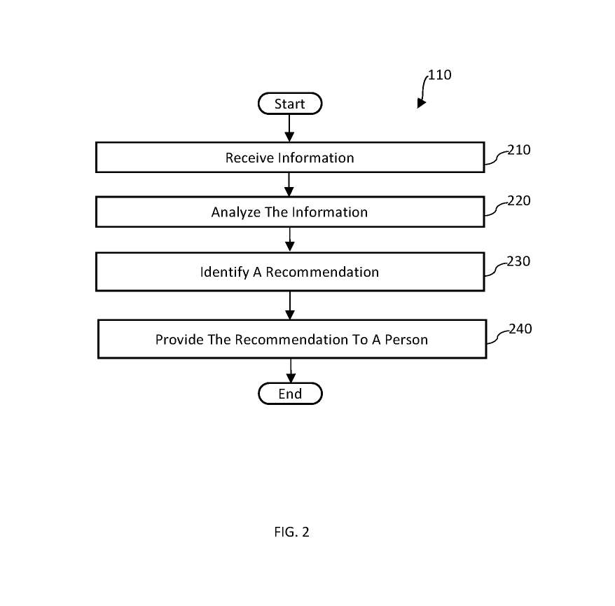

FIG. 2 depicts a flowchart of the steps of a recommendation program, executing within the computing system of FIG. 1, in accordance with an embodiment of the present invention. Recommendation program 110 provides a cognitive and dynamic business process, based on a user's natural language input.

In step 210, recommendation program 110 receives information. The information is any information that recommendation program 110 receives or retrieves that includes, but not limited to: monitored human interactions through video; monitored human interactions through audio; any information concerning the environment being monitored; electronic device activity; Internet of Things (IoT) communications; previous classifications and mappings; expert advice; previous recommendations; and heart rate monitors that may be used to determine the stress level of a situation is escalating. The information is actively and continuously monitored and captured.

In one embodiment, recommendation program 110 receives information from a user through user interface 130. In some embodiments, recommendation program 110 receives information from sensor 50. In other embodiments, recommendation program 110 retrieves information from database 120. Information retrieved from database 120 may be previous input of information from a different environment that is similar to the current environment that was received and stored to database 120 prior to the current scenario.

In step 220, recommendation program 110 analyzes the information. In one embodiment, recommendation program 110 analyzes the information from one or more devices in an area (environment) to identify at least two people and a context of the situation occurring between the at least two people, wherein the first person has an interaction with the second person. In some embodiments, recommendation program 110 continuously analyzes the received/retrieved information provided by the monitored environment, and other sources, with context information, identifying and analyzing current activity against categories of interaction based on interaction models of previous interactions stored to database 120.

In one embodiment, recommendation program 110 defines and stores to database 120 the current operating environment and likely relationships and human interactions present in the environment. Database 120 may store human interactions as machine readable models, previously provided by experts, augmented and/or tagged with situational classification data. Database 120 may also store response models, as captured previously by recommendation program 110 or experts, specifying possible response recommendations to particular interaction scenarios.

Through, both direct input and learning of the environment (e.g., through information obtained from sensor 50), in some embodiments, recommendation program 110 determines the context of the environment by determining which problem models to search, wherein the problem models may be models of previous problems within a previous environment stored to database 120. Recommendation program 110 uses the following questions, for example, but not limited to: what is the environment (e.g., home, school); how many individuals are present (e.g., a house with two children, a class with 10-20 students, a cafeteria of 50); who are the individuals involved, as well as their ages and genders; and what is the relationship between the individuals (e.g., a couple, family, extended family, students). In some embodiments, an individual's age, gender and relationship with one another can be determined/estimated based on information received from sensor 50.

Through the monitored environment and active interaction through sensors 50, in some embodiments, recommendation program 110 recognizes individuals through clustering analysis, using video and speech/sounds as input, weight of footsteps, and/or tone, timbre, volume, and emotion of voices. Recommendation program 110 recognizes activity from the tone of activities (e.g., generally quiet, clearly typing/working, dancing, bouncing, hyperactivity) and/or tone of communication (e.g., quiet discussion, presentation, loud classroom collaboration, laughing, crying). Recommendation program 110 establishes sentiment of the people or crowd (if there is a crowd of people).

In step 230, recommendation program 110 identifies a recommendation. In one embodiment, recommendation program 110 applies a behavioral model to the current context and the interaction within the current environment to identify a recommendation. The behavioral model may be a model of various previous interactions in an environment and the context, recommendations, and/or any other pertinent information associated with the previous interactions that may be able to help place the current situation in the current environment in a better context to find a recommendation/solution. In some embodiments, recommendation program 110 identifies appropriate responses and recommendations based on the response models of previous responses that match the classification of the current interaction within the monitored environment. In other embodiment, recommendation program 110 identifies a recommendation based on the classification and analysis of the interactions within the current environment.

In one embodiment, for example, recommendation program 110 determines the interaction is between a teacher and a student (based on analysis of the information obtained from sensor 50), and recommendation program 110 identifies an action for the teacher to apply to the situation. In such an embodiment, to identify the action to apply to the situation, recommendation program 110 may search database 120 for a previous, similar situation and recommend the action that was determined to be successful in handling the previous, similar situation. The similarity may be based on a predetermined threshold of similarity that may be defined by a user or recommendation program 110. For example, the predetermined threshold of similarity may be that in order to be considered similar, the previous situation must be in the same area with the same amount of people.

In some embodiments, recommendation program 110 identifies an absence of a solution to a goal and the recommendation is an idea for consideration to reach the goal. In such an embodiment, recommendation program 110 searches database 120 and determines there are no previous, similar situations that were resolved. In other embodiments, recommendation program 110 identifies a conflict within the environment and the identified recommendation is a first suggestion to resolve the conflict. Still, in some embodiments, recommendation program 110 determines that the first suggestion does not resolve the conflict and identifies a second suggestion to resolve the conflict.

In step 240, recommendation program 110 provides the recommendation to a person. In one embodiment, recommendation program 110 provides the recommendation to the person through user interface 130. In some embodiments, recommendation program 110 provides the recommendation to the person through sensor 50 (e.g., through audio or video). In other embodiments, recommendation program 110 provides the recommendation to the person through the identified recommendation being stored to database 120 for future use and available to be retrieved by the person through user interface 130 or otherwise.

In one embodiment, following step 240, recommendation program 110 requests the person to evaluate the quality of the recommendation, and recommendation program 110 stores feedback received from the person to database 120 for future use (not shown). In some embodiments, recommendation program 110 may tag the recommendation with metadata, based on the evaluation received from the person. An example of future use may be to use the feedback to identify more suitable recommendations in future similar interactions.

FIG. 3 depicts computer system 300, which is an example of a system that includes components of server 30 and/or computing device 40. Computer system 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307. Recommendation program 110 and database 120 may be downloaded to persistent storage 305 of server 30 through communications unit 307 of server 30. User interface 130 may be downloaded to persistent storage 305 of computing device 40 through communications unit 307 of computing device 40.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention, e.g., recommendation program 110 and database 120, can be stored on such portable computer readable storage media and can be loaded onto persistent storage 305 of server 30 via I/O interface(s) 306 of server 30. Software and data used to practice embodiments of the present invention, e.g., user interface 130, can be stored on such portable computer readable storage media and can be loaded onto persistent storage 305 of computing device 40 via I/O interface(s) 306 of computing device 40. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
receiving, by one or more processors, information from one or more devices in an area;
analyzing, by one or more processors, the information to identify at least two people and a context of an interaction, wherein a first person has the interaction with a second person;
applying, by one or more processors, a behavioral model to the context and the interaction to identify a recommendation, wherein the behavioral model is a model of a plurality of previous interactions in a plurality of areas, a plurality of contexts associated to the plurality of previous interactions, and a plurality of recommendations associated to the plurality of previous interactions; and
providing, by one or more processors, the recommendation to the first person.

2. The method of claim 1, wherein the behavioral model identifies an absence of a solution to a goal and the recommendation is an idea for consideration to reach the goal.

3. The method of claim 1, wherein the behavioral model identifies a conflict and the recommendation is a first suggestion to resolve the conflict.

4. The method of claim 3, further comprising:
responsive to determining the first suggestion does not resolve the conflict, identifying, by one or more processors, a second suggestion to resolve the conflict.

5. The method of claim 1, further comprising:
requesting, by one or more processors, the first person to evaluate a quality of the recommendation;
receiving, by one or more processors, from the first person, the evaluation of the recommendation; and
tagging, by one or more processors, the recommendation with metadata, based on the evaluation from the first person, wherein the metadata assists in identifying future recommendations.

6. The method of claim 1, further comprising:
comparing, by one or more processors, the received information to data within a database that includes the plurality of previous interactions in the plurality of areas, the plurality of contexts associated to the plurality of previous interactions, and the plurality of recommendations associated to the plurality of previous interactions; and
determining, by one or more processors, the received information is similar to the data within the database, based a predetermined threshold of similarity; and
identifying, by one or more processors, the recommendation, based on the similarity of the received information and the data within the database.

7. The method of claim 1, wherein the information includes audio, video, electronic device activity, and Internet of Things communications.

8. A computer program product comprising:
one or more computer readable storage media and program instructions stored on the one or more computer readable storage media, the program instructions comprising:
program instructions to receive information from one or more devices in an area;
program instructions to analyze the information to identify at least two people and a context of an interaction, wherein a first person has the interaction with a second person;
program instructions to apply a behavioral model to the context and the interaction to identify a recommendation, wherein the behavioral model is a model of a plurality of previous interactions in a plurality of areas, a plurality of contexts associated to the plurality of previous interactions, and a plurality of recommendations associated to the plurality of previous interactions; and
program instructions to provide the recommendation to the first person.

9. The computer program product of claim 8, wherein the behavioral model identifies an absence of a solution to a goal and the recommendation is an idea for consideration to reach the goal.

10. The computer program product of claim 8, wherein the behavioral model identifies a conflict and the recommendation is a first suggestion to resolve the conflict.

11. The computer program product of claim 10, further comprising:
responsive to determining the first suggestion does not resolve the conflict, program instructions, stored on the one or more computer readable storage media, to identify a second suggestion to resolve the conflict.

12. The computer program product of claim 8, further comprising:
program instructions, stored on the one or more computer readable storage media, to request the first person to evaluate a quality of the recommendation;
program instructions, stored on the one or more computer readable storage media, to receive, from the first person, the evaluation of the recommendation; and
program instructions, stored on the one or more computer readable storage media, to tag the recommendation with metadata, based on the evaluation from the first person, wherein the metadata assists in identifying future recommendations.

13. The computer program product of claim 8, further comprising:
program instructions, stored on the one or more computer readable storage media, to compare the received information to data within a database that includes the plurality of previous interactions in the plurality of areas, the plurality of contexts associated to the plurality of previous interactions, and the plurality of recommendations associated to the plurality of previous interactions; and
program instructions, stored on the one or more computer readable storage media, to determine the received information is similar to the data within the database, based a predetermined threshold of similarity; and
program instructions, stored on the one or more computer readable storage media, to identify the recommendation, based on the similarity of the received information and the data within the database.

14. The computer program product of claim 8, wherein the information includes audio, video, electronic device activity, and Internet of Things communications.

15. A computer system comprising:
one or more computer processors, one or more computer readable storage media, and program instructions stored on the one or more computer readable storage media for execution by at least one of the one or more computer processors, the program instructions comprising:
program instructions to receive information from one or more devices in an area;
program instructions to analyze the information to identify at least two people and a context of an interaction, wherein a first person has the interaction with a second person;
program instructions to apply a behavioral model to the context and the interaction to identify a recommendation, wherein the behavioral model is a model of a plurality of previous interactions in a plurality of areas, a plurality of contexts associated to the plurality of previous interactions, and a plurality of recommendations associated to the plurality of previous interactions; and
program instructions to provide the recommendation to the first person.

16. The computer system of claim 15, wherein the behavioral model identifies an absence of a solution to a goal and the recommendation is an idea for consideration to reach the goal.

17. The computer system of claim 15, wherein the behavioral model identifies a conflict and the recommendation is a first suggestion to resolve the conflict.

18. The computer system of claim 17, further comprising:
responsive to determining the first suggestion does not resolve the conflict, program instructions, stored on the one or more computer readable storage media for execution by at least one of the one or more computer processors, to identify a second suggestion to resolve the conflict.

19. The computer system of claim 15, further comprising:
program instructions, stored on the one or more computer readable storage media for execution by at least one of the one or more computer processors, to request the first person to evaluate a quality of the recommendation;
program instructions, stored on the one or more computer readable storage media for execution by at least one of the one or more computer processors, to receive, from the first person, the evaluation of the recommendation; and
program instructions, stored on the one or more computer readable storage media for execution by at least one of the one or more computer processors, to tag the recommendation with metadata, based on the evaluation from the first person, wherein the metadata assists in identifying future recommendations.

20. The computer system of claim 15, further comprising:
program instructions, stored on the one or more computer readable storage media for execution by at least one of the one or more computer processors, to compare the received information to data within a database that includes the plurality of previous interactions in the plurality of areas, the plurality of contexts associated to the plurality of previous interactions, and the plurality of recommendations associated to the plurality of previous interactions; and
program instructions, stored on the one or more computer readable storage media for execution by at least one of the one or more computer processors, to determine the received information is similar to the data within the database, based a predetermined threshold of similarity; and
program instructions, stored on the one or more computer readable storage media for execution by at least one of the one or more computer processors, to identify the recommendation, based on the similarity of the received information and the data within the database.
